(19) United States
(12) Patent Application Publication
(10) Pub. No.: US 2015/0046291 A1
(43) Pub. Date: Feb. 12, 2015

(54) PACKAGING OR SHIPPING MATERIALS ACQUISITION TECHNIQUES

(71) Applicant: Alexandre Archambault, Montreal (CA)

(72) Inventor: Alexandre Archambault, Montreal (CA)

(21) Appl. No.: 14/379,409

(22) PCT Filed: Feb. 21, 2013
(86) PCT No.: PCT/CA2013/050133

§ 371 Date: Aug. 18, 2014

Related U.S. Application Data
(60) Provisional application No. 61/601,097, filed on Feb. 21, 2012.

(51) Int. Cl. G06Q 30/06; G06K 9/18; G06K 9/62; G06F 17/30

(52) U.S. Cl. CPC G06Q 30/0633; G06Q 30/0627; G06F 17/30256; G06F 17/30424; G06K 9/18; G06K 9/6202
USPC 705/26.63

(57) ABSTRACT

Techniques for providing users with packaging and/or shipping materials may include receiving an optical image of an object having starting and shipping locations or keywords associated with the object; comparing with an optical recognition program, the optical image of the object to images of objects within a database of objects to identify the object, or the keywords in the search bar with words used in a description of objects in a database of objects to identify the object; assigning packaging and/or shipping information to the identified object; and ordering the packaging and/or shipping materials for the identified object and optionally supplying the packaging and/or shipping materials to the user at the starting location. Various related processes, systems and apparatuses are also provides.

### FIELD OF THE INVENTION

The present invention generally pertains to the field of the shipping industry. The present invention more particularly concerns processes and systems to automate and/or accelerate data entry of shipping information through image, shape and/or other recognition techniques to obtain quotes and/or purchase packaging and/or shipping materials such as shipping labels and supplies. The present invention also concerns processes and apparatuses to automate and/or accelerate weight entry with a mobile device, such as a smartphone or tablet, and the software thereof.

### BACKGROUND OF THE INVENTION

Packaging and shipping objects requires the necessary materials. Such materials may include boxes, envelopes, filler materials, labels, indicia, stamps, and so on, and depend on the nature and location of the object. The process of packaging and shipping objects can involve and sometimes require determining the size and weight of the object to be shipped. Such determinations are often laborious, inefficient or imprecise.

When preparing multiple objects for shipping, for example in the context of selling an item on an online platform, such as eBay™, the process of assessing the objects, ordering or obtaining appropriate packaging materials, and then shipping the packaged item can be a discouraging and time consuming operation.

More particularly, every day, millions of people and small-medium companies around the world buy and sell objects and goods over the internet through sites like eBay™′ Craigslist™, Kijiji™, classified ads, and the like. In 2005, the New York Times reported 4.4 million transactions occurred daily on eBay™ alone through 168 million registered users worldwide. In the last quarter of 2011, eBay™ grossed total revenues of $3.4 Billion, a 35% increase from the same timeframe in 2010.

Problems encountered in this area pertain to the shipping costs and the non-user-friendliness of the general shipping process.

It has been well known for years by the purchasers of goods over eBay™ that the shipping costs billed by the seller is always, albeit exception, very high and rarely reflects what the shipping actually costs since the seller rarely goes through the exercise of getting an accurate quote for every potential buyer, by definition all located in different places around the world.

Should a potential buyer require an estimate, the seller has to measure and weigh the object manually, go on the individual websites of FedEx™, UPS™, USPS™, Post Canada™ and enter manually the dimension and weight numbers as well as the potential buyer's address to get an estimate. This usually takes time and the seller, not knowing if the buyer will actually buy the object, does not go through all this hassle and usually gives a conservative estimate. Example: shipping to the lower 48 states will cost 25$, Europe will cost 75$, and Asia 100$.

Unless he knows the weight and dimensions of the object he wants to purchase, it is very hard for a potential buyer to challenge the quote given by the seller. Hence, sellers make money on excessive shipping fees and buyers cannot easily—and hence do not—do anything about it.

On top of this, the shipping process is not user-friendly for the seller. The whole process of getting a right-sized box/envelope and printing shipping labels is time consuming and archaic.

Once the item is sold the seller can either (i) purchase a box or envelope though a brick and mortar or online store (after going through all the options and guesstimating what box is the best size-price), print a shipping label and ship the item. This is time consuming.

Or (ii) if the seller has a box handy for the item he wants to ship, he can print the shipping label from home on his personal printer, manually entering on the FedEx™, DHL™, USPS™ or Post Canada™ website the weight and dimension of the item, enter the location of the buyer, which dimensions and weight will have been previously measured by hand.

There is indeed a need for a technology that overcomes at least some of the disadvantages and challenges of the known techniques for packaging and shipping objects, as described above.

### SUMMARY OF THE INVENTION

The present invention provides various techniques for packaging and/or shipping materials acquisition.

In some implementations, there is a process for providing users with packaging and/or shipping materials, comprising:
receiving either an optical image of an object having a starting location and a shipping location or keywords associated with the object, optionally via a search bar;
comparing either with an optical recognition program, the optical image of the object to images of objects within a database of objects to identify the object, or the keywords in the search bar with words used in a description of objects in a database of objects to identify the object;
assigning packaging and/or shipping information to the identified object; and
ordering the packaging and/or shipping materials for the identified object and optionally supplying the packaging and/or shipping materials to the user at the starting location.

In some implementations, the process further includes identifying the starting location of the object by a GPS system.

In some implementations, the packaging and/or shipping materials include boxes and/or padded envelopes.

In some implementations, the packaging and/or shipping materials further include wrapping paper, string, tape, glue, labels, indicia and/or stamps. The indicia may include a sticker indicating fragility of the object.

In some implementations, the step of comparing includes comparing the shape of the object to the shapes of the objects within the database.

In some implementations, the step of comparing includes comparing the colour of the object to the colours of the objects within the database.

In some implementations, the step of comparing includes comparing a combination of features of the object to a corresponding combination of features of the objects within the database. The combination of features may be selected from shapes, colours, height, depth, width, quantity, weight or a combination thereof.

In some implementations, the objects in the database are associated with reference identification information selected from shapes, colours, height, depth, width, quantity, weight or a combination thereof, and with reference packaging and/or shipping information.

In some implementations, packaging and/or shipping information includes minimum package size, recommended package size, minimum weight bearing package strength, recommended weight bearing package strength, special shipping requirements, fragility, starting location, shipping location, required package shape, alternative package shapes, recommended shipping standards and/or luxury shipping standards.

In some implementations, the assigned description of the object and/or packaging and/or shipping information includes maximum dimensions and weight of the object and the packaging and/or shipping materials are ordered in accordance with the maximum dimensions and weight of the object.

In some implementations, the ordering of the packaging and/or shipping materials includes ordering from a post office or shipping materials provider to send the materials to the user at the starting location.

In some implementations, the ordering of the packaging and/or shipping materials includes an initial step of obtaining quotes from suppliers.

In some implementations, the process further includes obtaining the optical image from the object using a mobile phone or tablet device and sending the optical image via the mobile phone or tablet device to the database.

In some implementations, the database is associated with a server and the optical image is sent by the mobile phone or tablet device to the database via the server.

In some implementations, the mobile phone or tablet device comprises a software application for obtaining the optical image.

In some implementations, the mobile phone or tablet device comprises a software application for sending the optical image.

In some implementations, the mobile phone or tablet device comprises a software application for ordering or purchasing the packaging and/or shipping materials.

In some implementations, the software applications for obtaining the optical image, sending the optical image, and ordering or purchasing the packaging and/or shipping materials, are separate from each other.

In some implementations, the software applications for obtaining the optical image, sending the optical image, and ordering or purchasing the packaging and/or shipping materials, are part of the same overall software application.

In some implementations, the process further includes allowing the user to purchase the packaging and/or shipping materials in an external application with respect to obtaining and sending the optical image.

In some implementations, the database is crowd sourced. The process may further include building the crowd sourced database by:
providing a platform for the users to send the optical images of the corresponding objects for packaging and/or shipping identification;
receiving either the optical images of the objects from the users or keywords associated with the object via the search bar from the users;
for each object, either comparing with the optical recognition program the optical image of the object to images of objects within the crowd sourced database of objects or comparing identical such keywords in the search bar with the words used in the description of the objects in the crowd sourced database of objects;
for objects not found in the crowd sourced database:
   receiving a description of the object; and
   receiving either optical images of the objects from the users or keywords associated with the object via a search bar; and
   for each object, either comparing with optical recognition program the optical image of the object to images of objects within the crowd sourced database of objects or compare identical such keywords in the search bar with the words used in the description of the objects in the crowd sourced database of objects, and/or;
   ordering packaging and/or shipping materials for the object and/or;
   supplying the packaging and/or shipping materials to the corresponding user; and
for objects found in the crowd sourced database:
   ordering packaging materials for the identified object, and supplying the packaging and/or shipping materials to the corresponding user; and
   supplying the packaging and/or shipping materials to the corresponding user.

In some implementations, the database is located or saved in the cache memory of the mobile phone or tablet device.

In some implementations, the database comprises objects described by the user, which objects will only be accessible by that user for supplying the packaging and/or shipping materials corresponding to those objects;

It should be noted that in various implementations the objects are any physical objects.

In some implementations, there is provided a process for building a crowd sourced database of objects for packaging and/or shipping the objects, comprising:
providing a platform for users to send optical images of corresponding objects for packaging and/or shipping identification;
receiving optical images of the objects from the users;
for each object, comparing with optical recognition program the optical image of the object to images of objects within the crowd sourced database of objects;
for objects not found in the crowd sourced database:
   receiving packaging and/or shipping information from the corresponding user and updating the crowd sourced database therewith, and
   ordering packaging and/or shipping materials for the object; and
   supplying the packaging and/or shipping materials to the corresponding user; and
for objects found in the crowd sourced database:
   ordering packaging materials for the identified object, and
   supplying the packaging and/or shipping materials to the corresponding user.

In some implementations, there is provided process for building a crowd sourced database of objects for packaging and/or shipping the objects, comprising:
providing a platform for users to send optical images of corresponding objects for packaging and/or shipping identification;
receiving either optical images of the objects from the users or keywords associated with the object, optionally via a search bar;
for each object, either comparing with optical recognition program the optical image of the object to images of objects within the crowd sourced database of objects or comparing identical such keywords in the search bar with the words used in the description of the objects in the database of objects; and; and
receiving a description of the object and/or packaging and/or shipping information from at least some of the users regarding the corresponding objects and updating the crowd sourced database therewith.

In some implementations, there is provided a system for providing users with packaging and/or shipping materials, comprising:
an image acquisition device operable for obtaining an optical image of an object;
a database comprising packaging and/or shipping information and optical images associated with objects and their description;
a network or communication means between the image acquisition device and the database; and
a processing device programmed to:
   compare the optical image of the object to images of objects within the database of objects to identify the object; and/or
   compare identical such keywords in a search bar with the words used in the description of the objects in the database of objects; and
   ordering the packaging and/or shipping materials for the identified object.

The system may be used in association with one or more of the processes described herein and may have various additional components and/or modules to do so.

In some implementations, there is provided a process for providing users with packaging and/or shipping materials, comprising:
transferring data related to an object having a starting location and a shipping location, from a mobile phone or tablet device to a database;
comparing the data of the object to data of objects within the database of objects to identify the object;
assigning packaging and/or shipping information to the identified object; and
allowing the user to obtain the packaging and/or shipping materials based on the packaging and/or shipping information for the identified object.

In some implementations, the data comprises optical data. The optical data may include a digital photograph and/or a bar code and/or a QR code.

In some implementations, the data comprises the description of the object including a category of the object and/or more or more associated trademarks of the object.

In some implementations, there is provided a process for providing users with packaging and/or shipping materials, comprising:
receiving either an optical image of an object having a starting location and a shipping location or keywords associated with the object via a search bar;
comparing either, with an optical recognition program, the optical image of the object to images of objects within a database of objects to identify the object within a category of objects, or the keywords in the search bar with words used in a description of the object in the database of objects, and wherein the object is within a category of objects;
wherein the category of objects has a description and/or packaging and/or shipping information associated to the category comprising average packaging and/or shipping information of the objects in the category; and
ordering and/or receiving quotes for the packaging and/or shipping materials for the identified category of objects and, optionally, supplying the packaging and/or shipping materials to the user at the starting location.

In some implementations, there is provided an apparatus for obtaining packaging and/or shipping information for an object, comprising:
a protective case associated with a mobile phone or tablet;
a scale tool connected to the case for weighing the object and/or a measurement tool connected to the case for measuring a size of the object, to thereby obtain the packaging and/or shipping information for the object; and
means for entering the packaging and/or shipping information of the object into the mobile phone or tablet.

The apparatus may be used in association with one or more of the processes and system described herein and may have various additional components to do so.

In some implementations, there is provided a process for providing users with packaging and/or shipping materials, comprising:
receiving identification information regarding an object having a starting location and a shipping location;
comparing the identification information of the object to information of objects within a database of objects to identify the object;
assigning packaging and/or shipping information to the identified object; and
ordering the packaging and/or shipping materials for the identified object and, optionally, supplying the packaging and/or shipping materials to the user at the starting location.

In some implementations, the identification information comprises an optical image of the object taken by the user. In some implementations, the identification information comprises keywords associated with the object entered by the user. The process described above may also have one or more of the features described in various other implementations of the processes discussed herein.

### BRIEF DESCRIPTION OF THE DRAWINGS

FIG. 1 (FIGS. 1a to 1i) is a process flow diagram of various aspects of an embodiment of the present invention.

FIGS. 2a to 21 are a series of screenshots for an object found scenario.

FIGS. 3a to 3j are a series of screenshots for an object not found scenario.

FIG. 4 is a general process flow diagram.

### DETAILED DESCRIPTION

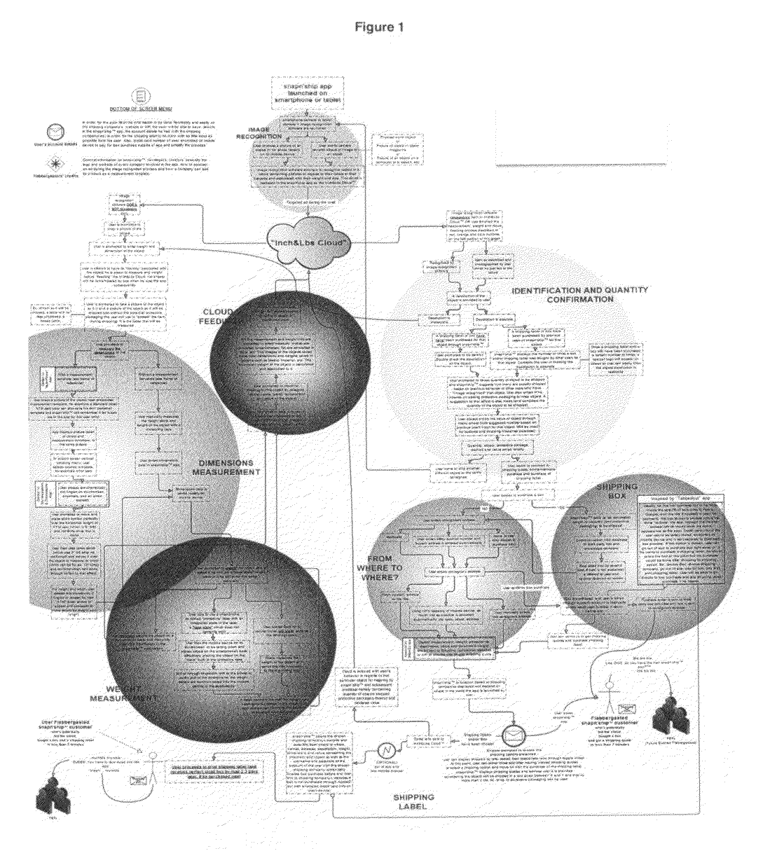

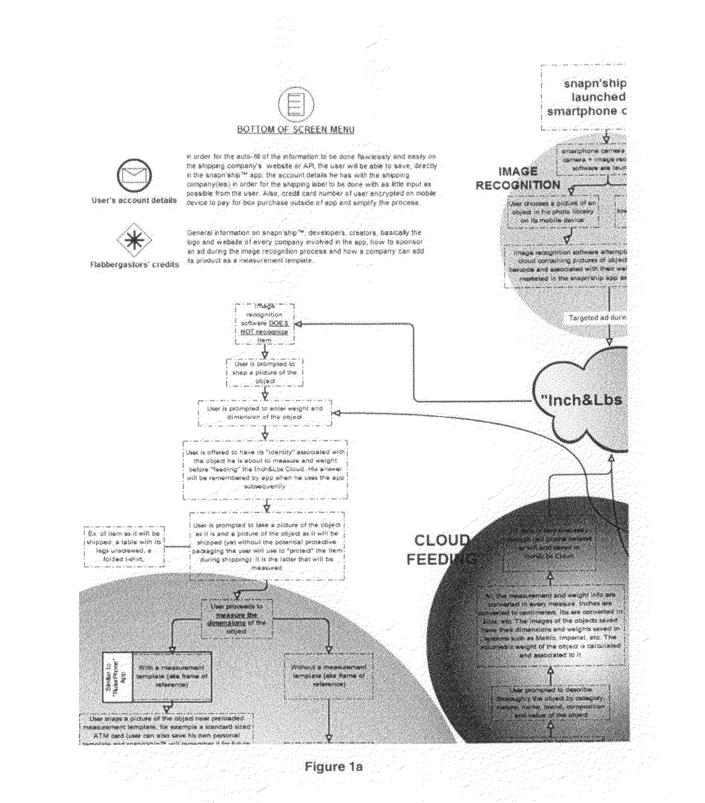

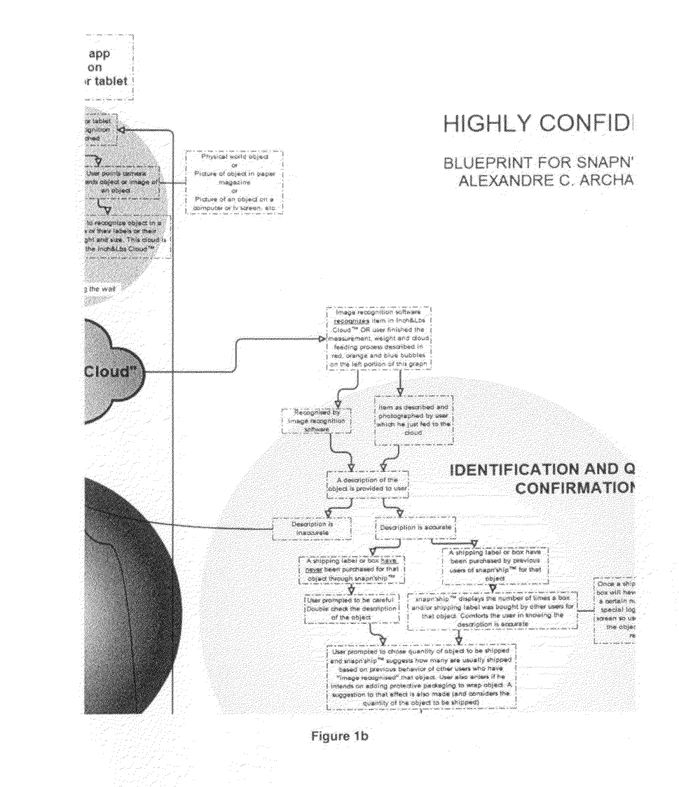

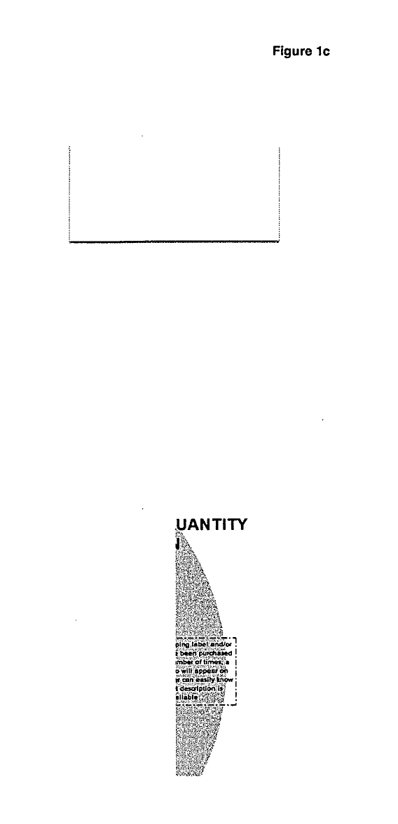

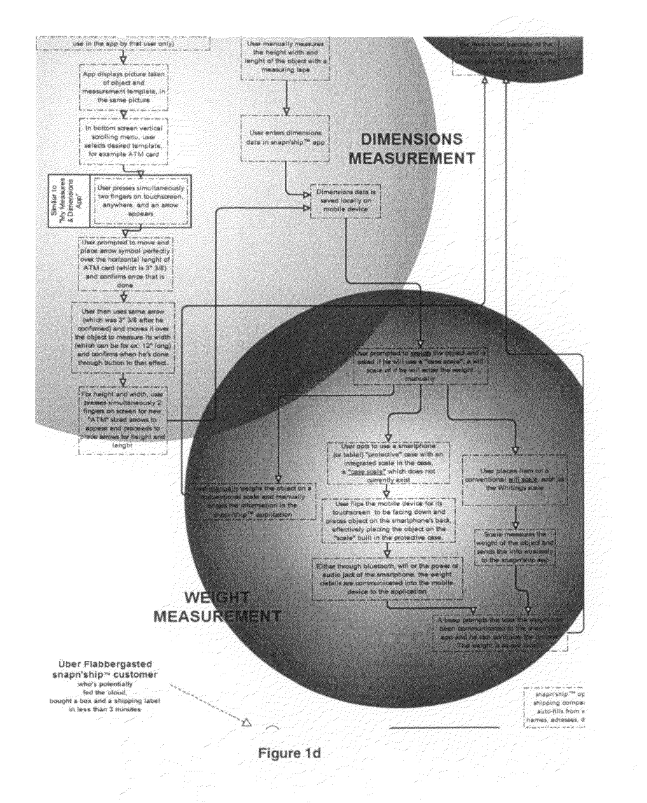

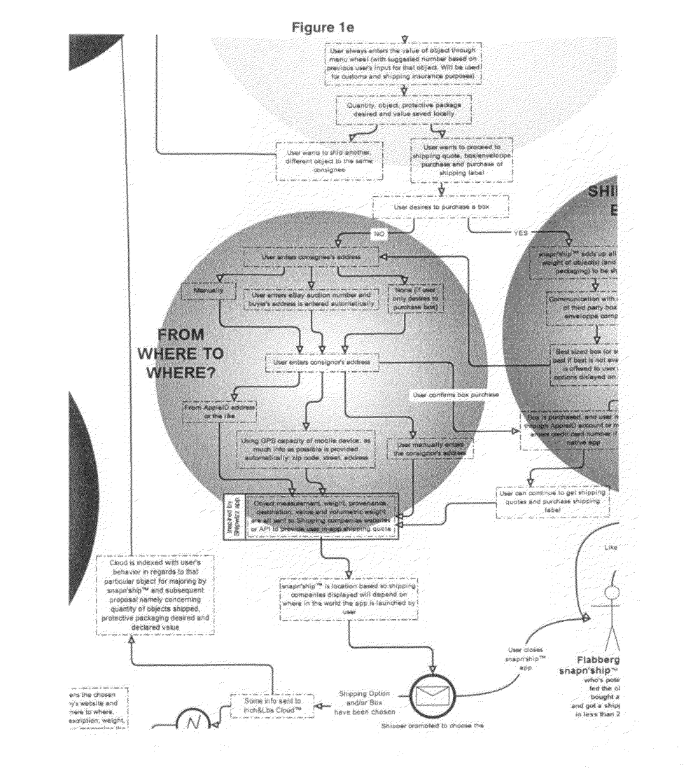

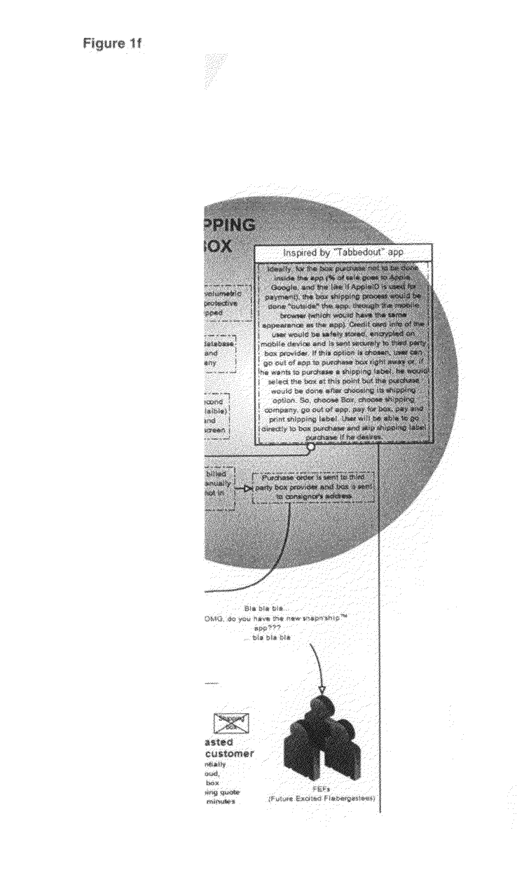

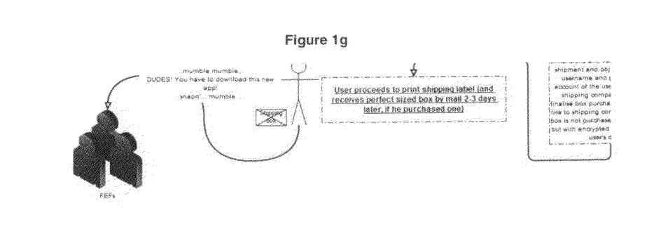

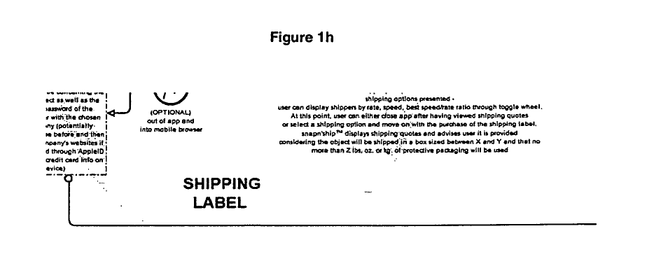

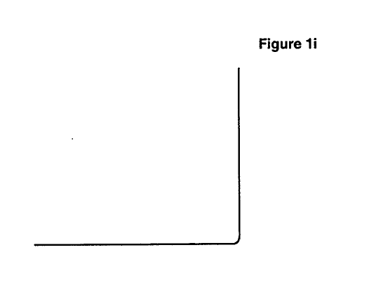

FIG. 1 illustrates various optional aspects of an embodiment of the present invention.

In some implementations, the process is achieved through a mobile application (for smartphones or tablets) and provides a much quicker way to obtain a quote and/or purchase a shipping label and shipping supplies for the item to be shipped. The process can allow buyers to quickly and easily obtain shipping quotes with their mobile phone for the item they wish to purchase.

In some implementations, the apparatus can be used within the process to speed up the weight data entry within the method by sending the weight data measured by the apparatus directly within the mobile application software without the user having to manually enter the weight data himself within the application. The apparatus may include an integrated wifi-scale and protective case.

In accordance with some implementations, the process may include five (5) general steps (for a seller of an object);
1. Application (“app”) is launched on mobile device and camera is automatically activated. User points built-in camera of mobile device towards the object. Any object—including assembled products, generally planar or three-dimensional objects, or sub-components of products—may be targeted.
2. Cloud Based: Through the image (or shape) recognition API or simply using a search bar with key words, the object is recognised or identified in its database (or Cloud; the database of pictures of objects associated to their description, dimension and weight is here proposed to be in remote server known as a Cloud, but the database could be partially or completely downloaded into the user's mobile device and updated from time to time with new data having been uploaded to the database by other users). In the Cloud, every object (picture) may have shipping and packaging information associated to it (weight, dimensions, average declared value for customs purposes, if the object is usually shipped with protective packaging material and the quantity of that material).
3. Crowd Sourced: User confirms if the physical object he searched for is actually the one that has been “image recognised” from the Cloud or found through the search bar. If not, user takes pictures (and/or video) of the object and can enter the dimension, weight and description of the object he photographed, which will all be saved in the Cloud and can be accessed and used by any other user of the application thereafter. To encourage people to “feed” the Cloud, the user's name can (that person will have the choice) be associated forever with the picture and description the user provided.
   The dimensions may be entered directly on the screen with arrows and a frame of reference as in the RulerPhone app and the arrows as in the My Measures&Dimensions app, both currently available on the AppStore™. The weight can be entered manually or wirelessly with a wifi-scale, for example.
   To facilitate the weight data entry in the application and be able to do this anywhere, it could also be done through a case-scale. Simply “flip” the mobile device on its touchscreen, put the object on the case and it will automatically enter the object's weight in the app. This case-scale apparatus is another embodiment of the present invention.
4. The seller enters the address of the buyer in the app and the seller can use its AppleID/Android address as its selling location, its GPS location or enter any other location from where the item will be shipped.
5. Seller may be provided with quotes from a plurality of shipping companies.
   The shipping companies displayed depend on where in the world the app is launched (app is location based if smartphone is GPS enabled) and which shipping carrier's APIs are associated to the territory in which the object is sent from. The app incorporates many shipping carriers APIs and all the information concerning the weight and dimensions of the object will be sent to those APIs to generate shipping quotes and purchase shipping labels. Seller can print shipping label the way he usually does (personal printer) and may use the “print” option in iOS5+™ to print wirelessly directly from his phone.
   If the user does not desire to purchase a box, he can also enter the size of the box he will use. The app will also suggest, out of a database of 500+ box sizes, the best sized box to ship the object in question. User might use a box of identical size to that which is suggested or provide the details (size and weight) of the box he will use.
   The box can be purchased inside the app with a Paypal account (or directly with his credit card, which information will be encrypted on its mobile device)—the purchase would be done outside the app within the web browse. The box can be sent to any address entered by user. User then receives box in the mail 1 or 2 days later and the item is ready to be shipped either by FedEx coming to pick it up or the seller dropping it in a mailbox.

In accordance with some implementations, the process may include three (3) general steps (for a buyer). This is preferred for the buyer when the Cloud will contain hundreds of thousands of pictures (i.e. thoroughly described items associated with shipping and packaging information);
1. App is launched and buyer can search the Cloud through a search bar or take a picture of the object he wants to buy (even if the object is on the screen of his computer).
2. Buyer enters seller's zip code (or city) and shipping estimates will be provided with either buyer's saved address, GPS location or any other manually submitted address.
3. Shipping quotes are provided for a plurality of shipping companies and the box in which the package will be sent is suggested by the app.

The app may also be simply accessed to purchase a box or envelope for a given item.

As mentioned above, in some implementations, the invention is operated in connection with a mobile application accessed from a mobile device with a camera and wireless capabilities (such as Wi-Fi, Bluetooth, Telephone Network, etc.).

FIG. 1 illustrates a block sequence chart of a process and system according to some aspects of the present invention. The sequence chart may be used for a mobile app that is further described below and may be referred to herein as “Snapn'Ship™”.

Summary table of optional details

When user enters a dimension and weight in the Cloud, the description has to be
precise;
Description of object;
What's the Brand - be as specific as possible (if applicable);
What is it made of?
(since a pewter tea pot may not weigh as much as a ceramic teapot)
Goal: the Cloud must not be cluttered with unusable pictures with inappropriate
descriptions.
For potential buyers to use the Cloud without photographing an object, a search bar
within the application will allow them to search the Cloud by keywords.
Search bar must correct queries entered by user; Ex; Moovement Skis automatically
corrected to Movement Skis with a “did you mean Movement Skis” prompt?
Create an interface similar to that of the “Measures and Dimensions” application to use
arrows and a magnifying glass to tag each picture with 3 dimensions (Height × Width ×
Depth)
The image recognition software is not perfect for recognising certain generic objects;
example; A pair of Levi's jeans vs. a pair of Rock&Republic jeans.
Thus, cloud feeders will be prompted to snap a picture of the jean tag so the tag can be
associated to an object.
OTHER POSSIBILITY; without recognising specifically that a jeans is precisely a Levis
501 with a 32 waistline, the app can simply contain average info of generic such objects
within that category of objects then give the user the possibility to enter its waistline and
length. The Cloud will have a database saying that a pair of jeans with, for example, a 34
waist and a 33 length weighs in average 2.5 lbs and allow the user to snap a picture of
the tag and give thorough description if he wishes the quote provided to be as accurate
as possible. So for each category of objects, we would have an average weight and
measurement suggested in the app for the purpose of providing shipping quotes for our
users to purchase shipping labels. Another example of this could be a television. Without
knowing specifically which model of television, the app would still have average weights
and dimensions, of 27”, 32”, 40” (etc.) televisions. This is what is meant for the category
of objects. Same could be said of computer mouses, automobile tires and many other
objects will can be labeled into a larger of category of objects, in the same fashion
eBay ™ prompts users to place all items sold on the site into certain categories so users
can browse by category of objects.
Same with shoes; men or women's? Athletic or casual? Heel? Flat? Length? The Cloud
will have averages stored.
Users will be able to place an object, like a white sheet of paper or a MetroCard near the
object to determine automatically its size. This will serve as a frame of reference. The
user could place a standard sized MetroCard or an A4 (Europe) or standard 8.5 × 11
(North America) which would be selected in the app, the app would know the size of the
paper (or user would place an arrow on it as described in sequence chart enclosed) and
depending on how big or small the object is compared to the sheet of paper, the app will
be able to determine the size of the object.
Language of the descriptions; we will start with English but it will be possible to add
descriptions in other languages.
Give the option to the person feeding the cloud to describe the object in English AND
any other language.
The app will suggest and prompt to the user if the object is usually shipped in a pair (or 3
at the time, etc.). The app will be able to suggest this once the item will have been
shipped many times and a “shipping profile” of that object will have been built. The
shipping profile should be auto-generated after the object is shipped multiple times the
same way (i.e. by pair, one at the time, 4 at the time, etc.).
The app will have to calculate, at the same moment the dimensions and weight of an
object are entered in the Cloud, the volumetric weight of each object and be associated
with the picture (volumetric weight in kg = W × L × D/6000).
FYI; FedEx ™ charges for the highest of volumetric weight vs actual weight.
When a price will be given to the user for a specific object, the app will let the user know
that the pricing is guaranteed if the object in question is shipped in a box with a minimal
size of X and a maximal size of Y OR if the object is shipped in a padded envelope of X
size. And the user will have the possibility to enter the size and weight of his own
shipping package if desired.
When proposing a box or envelope to user, it should always be a little larger than the
object itself to allow the user to add packing material to protect the object OR ask the
user if he wishes to add protective packing material (a little or a lot) and add a certain
more space in the box, accordingly. This added space would be distributed evenly in the
box so the packing material can protect the object as a whole and not only its lower part
or superior part. This will be relevant when proposing what box to purchase.
Through an agreement with eBay ™, we want sellers, in the “shipping cost” description of
the item to be sold on the eBay ™ website, to simply refer the potential buyer to use the
snapn'ship ™ app in order for that potential buyer to obtain shipping quotes for the object
in question. The potential buyer will then simply enter the auction number within the
snapn'ship ™ app (manually or through image recognition) to obtain shipping quotes for
that item with or without a box (by using the GPS inside the phone and/or saved address
of the potential buyer to know where the item will be sent, the auction info to know from
where the item will be sent, and auctioned item will be recognised inside the Cloud to
provide shipping and packaging information in order to obtain accurate quotes).
Declared value could be given by the seller when posting his item for auction on eBay ™
and be entered directly within shipper's website through snapn'ship ™ to obtain quotes
and/or purchase shipping labels.

In one example of the implementation of the present invention, the object may be sporting equipment, such as a set of road bike wheels, which need to be sold on eBay™ or another online auction or marketplace. It is relatively difficult to rapidly determine the weight and dimensions of road bike wheels, and thus in what type of box they should be shipped. In some embodiments of the processes, systems and apparatuses described herein, there is an app through which one could simply “snap” a picture of the object (or rather simply point the camera of his mobile device towards the object without the camera actually taking a picture at that moment) and know exactly its weight, dimensions and then obtain shipping quotes from where one wants to ship and even buy a perfectly sized shipping box in just a couple of minutes, or simply obtain quotes on shipping materials such as boxes.

Current smartphones and tablets are powerful tools including built-in cameras with high-resolution, cloud computing is increasingly popular, and image recognition methods are well known and may be used in connection with the present invention.

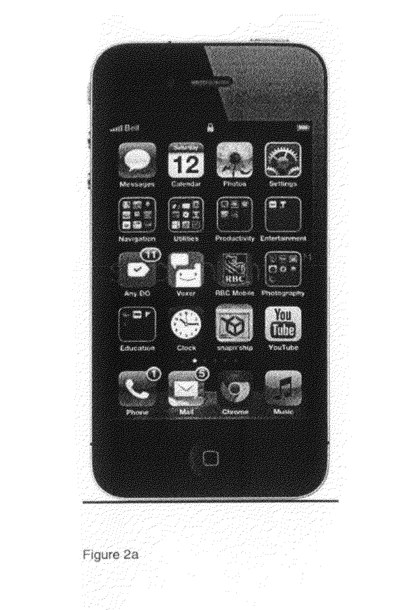

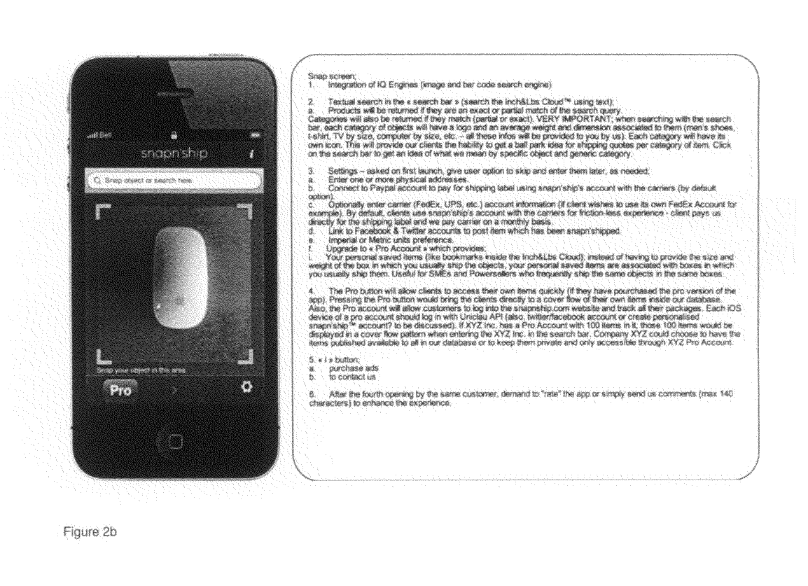

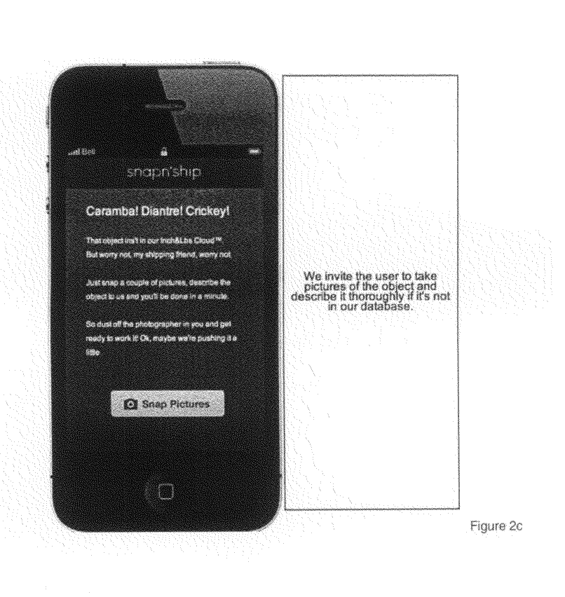

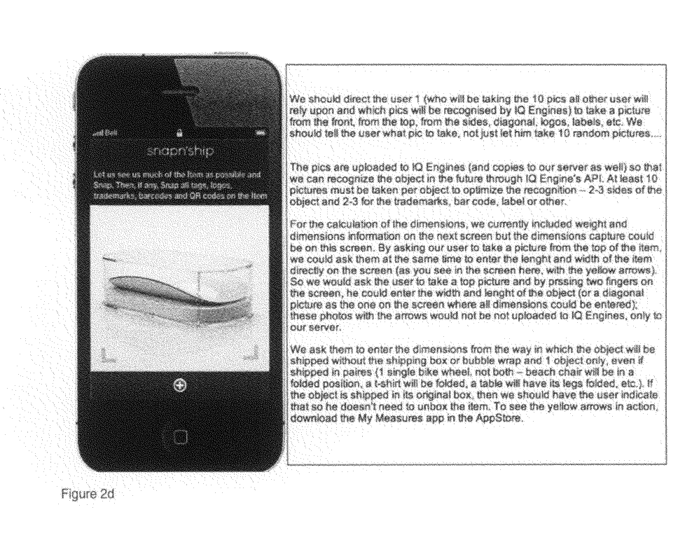

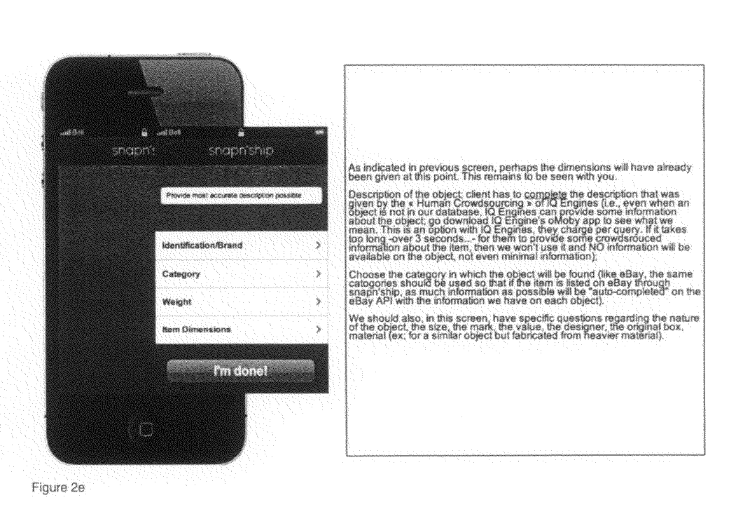

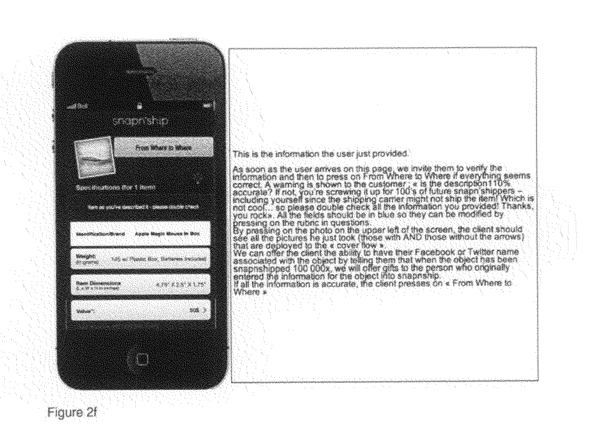

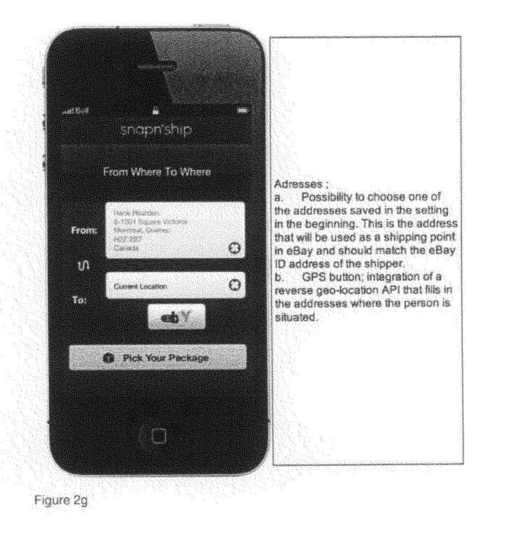

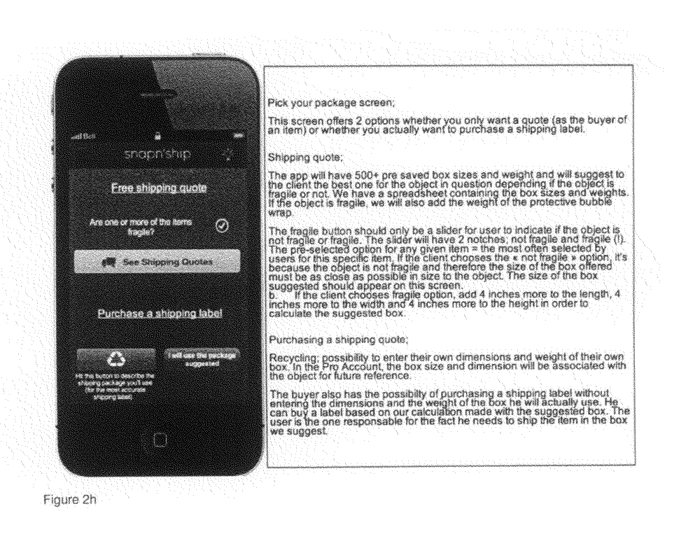

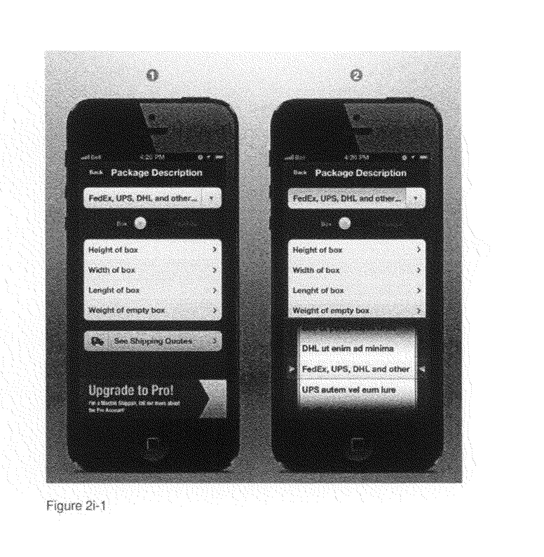

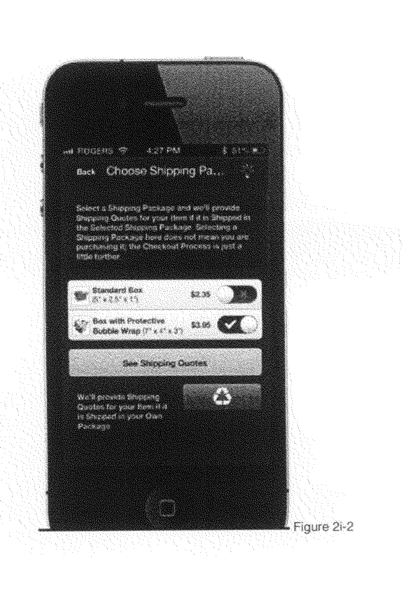

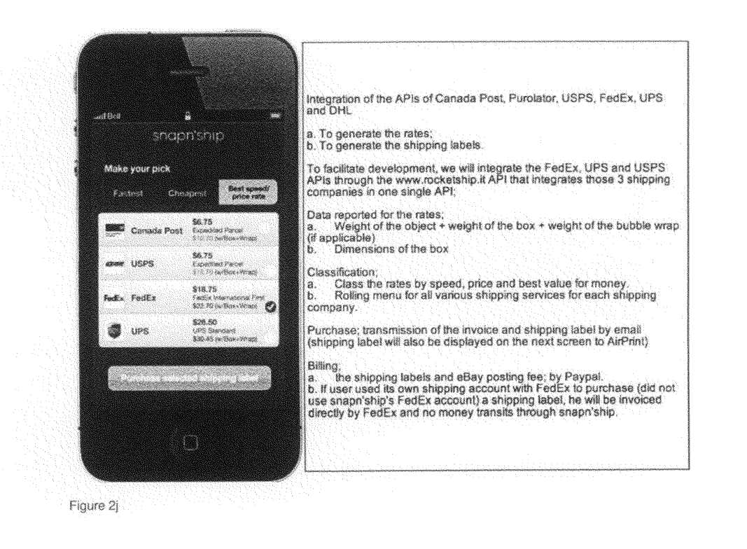

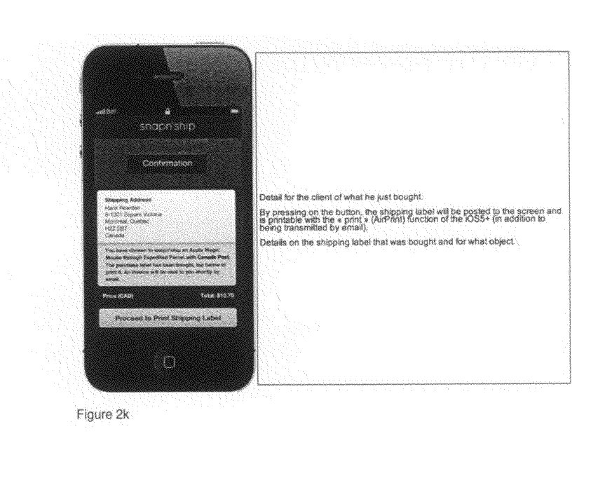

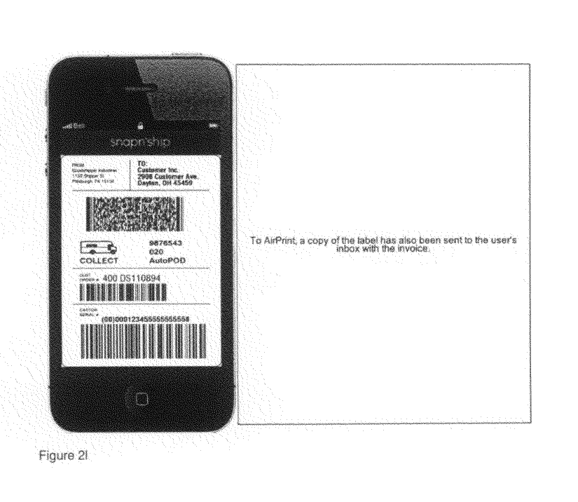

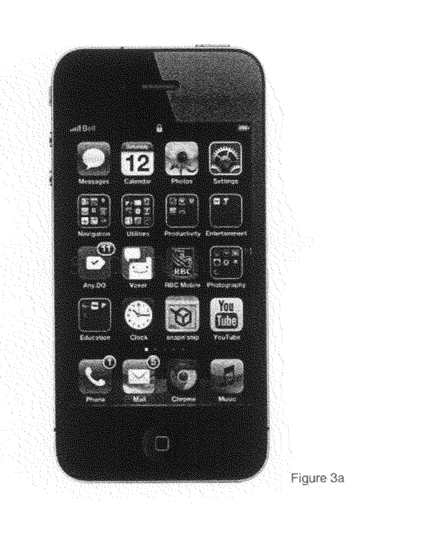

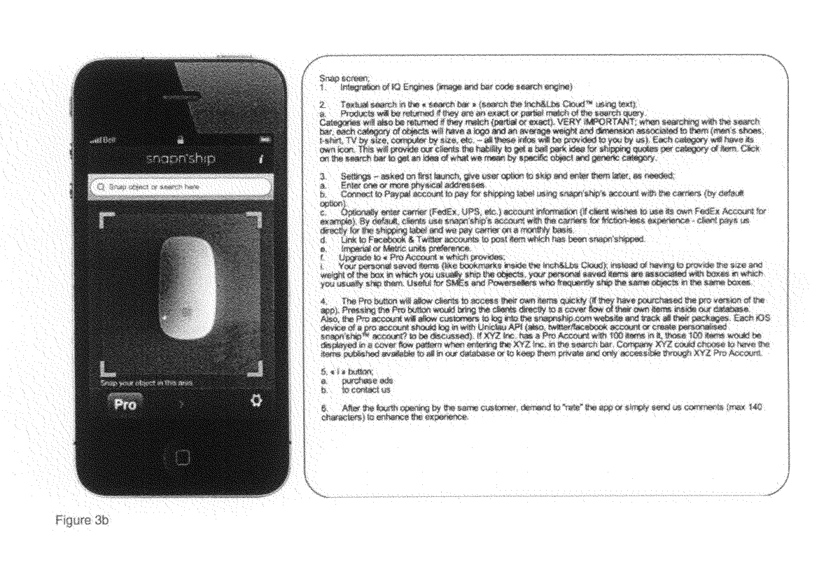

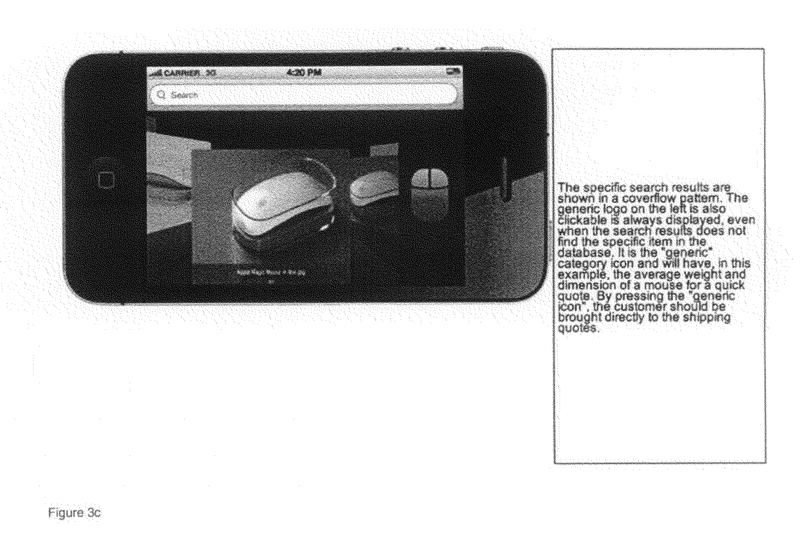

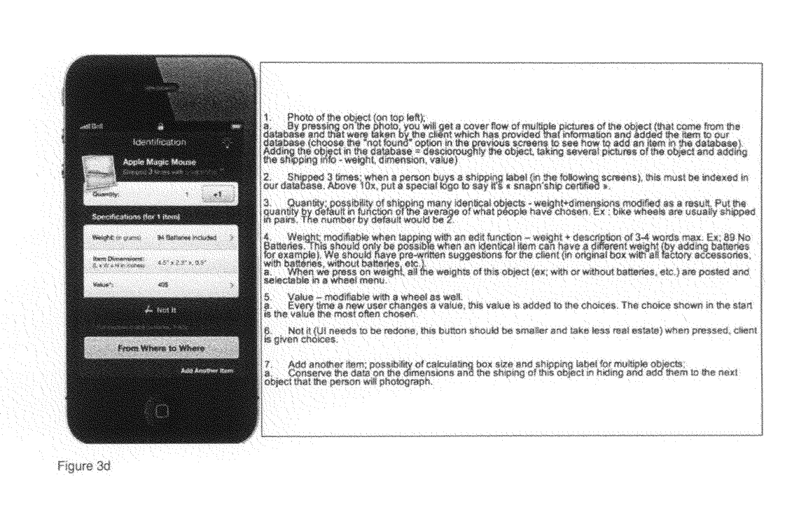

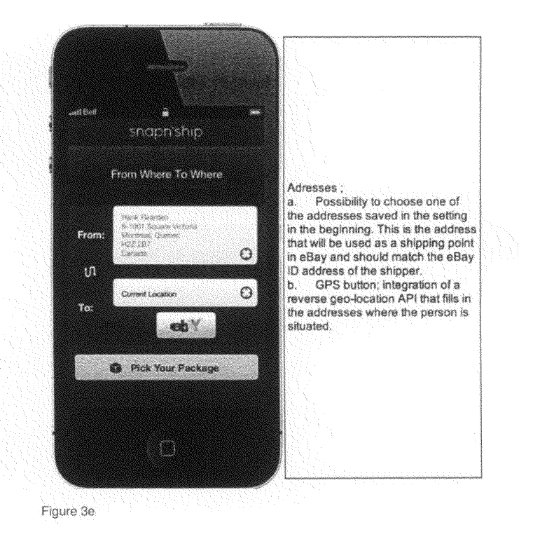

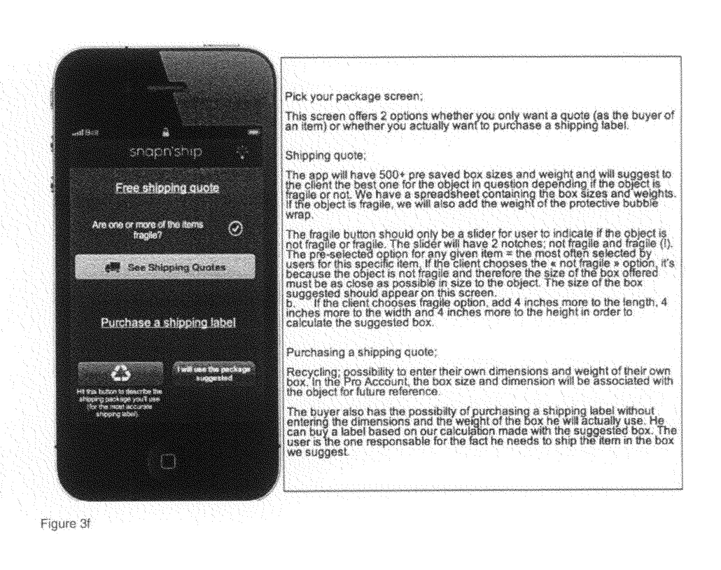

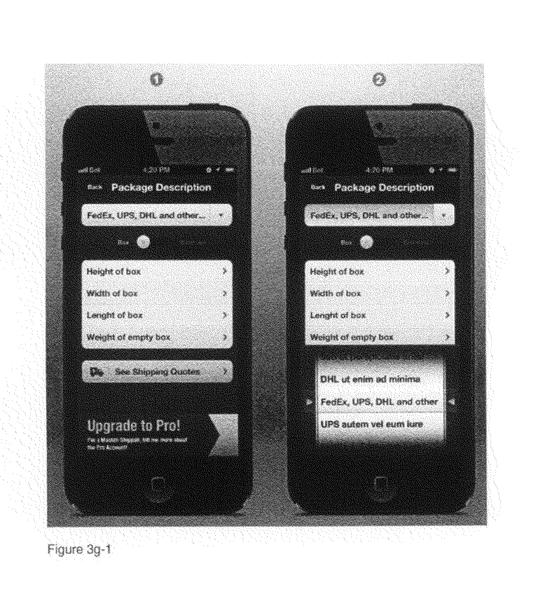

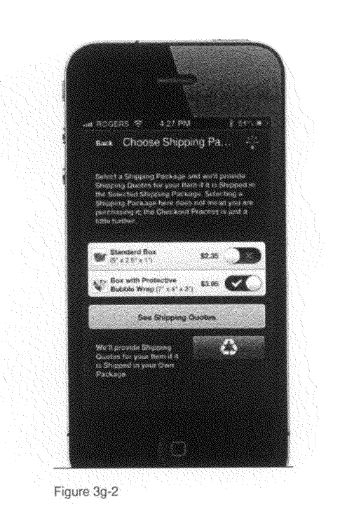

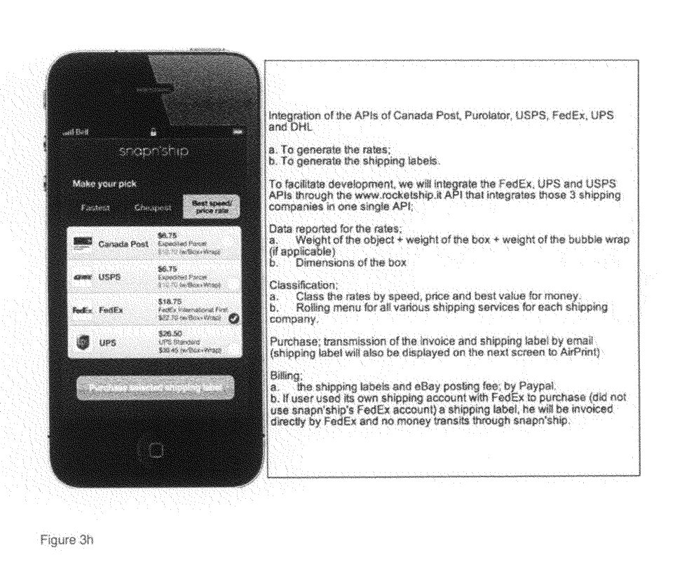

FIGS. 2a to 3 are a series of screenshots for an object found scenario and FIGS. 3a to 3 are a series of screenshots for an object not found scenario.

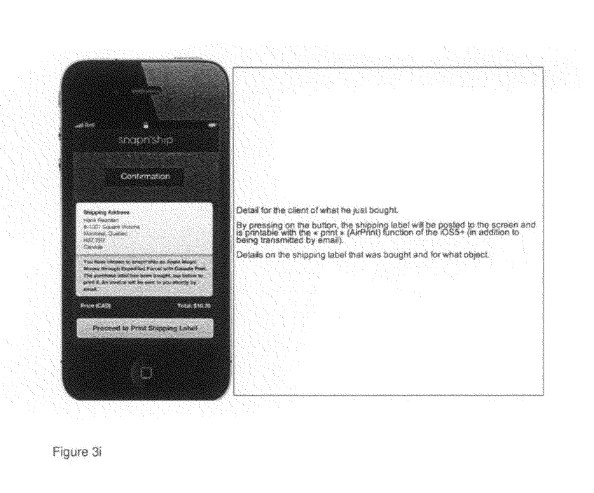

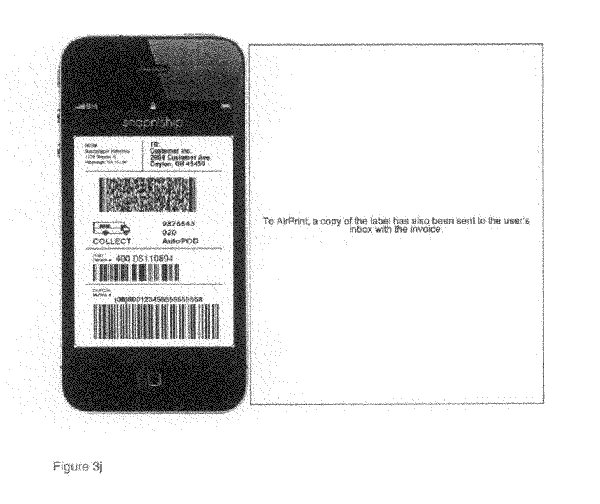

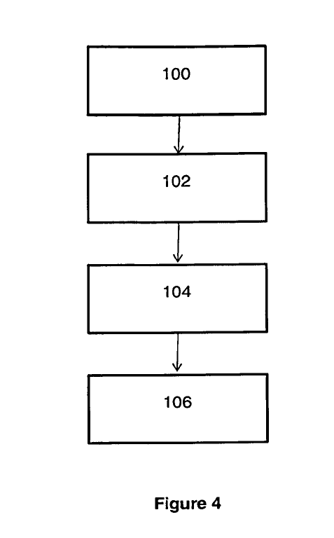

Referring to FIG. 4, the process for providing users with packaging and/or shipping materials may include a number of steps. The process may include a receiving step (100) of receiving either an optical image of an object having a starting location and a shipping location or keywords associated with the object, optionally via a search bar. The process may also include a comparing step (102) of comparing either with an optical recognition program, the optical image of the object to images of objects within a database of objects to identify the object, or the keywords in the search bar with words used in a description of objects in a database of objects to identify the object. The process may include an assigning step (104) of assigning packaging and/or shipping information to the identified object. The process may then include an ordering step (106) of ordering the packaging and/or shipping materials for the identified object and optionally supplying the packaging and/or shipping materials to the user at the starting location.

The documents, websites and other references mentioned herein are hereby incorporated by reference.

1. A process for providing users with packaging and/or shipping materials, comprising:
receiving either an optical image of an object having a starting location and a shipping location or keywords associated with the object, optionally via a search bar;
comparing either with an optical recognition program, the optical image of the object to images of objects within a database of objects to identify the object, or the keywords in the search bar with words used in a description of objects in a database of objects to identify the object;
assigning packaging and/or shipping information to the identified object; and
ordering the packaging and/or shipping materials for the identified object and optionally supplying the packaging and/or shipping materials to the user at the starting location.

2. The process of claim 1, wherein further comprising identifying the starting location of the object by a GPS system, wherein the packaging and/or shipping materials include boxes and/or padded envelopes, wherein the packaging and/or shipping materials further include wrapping paper, string, tape, glue, labels, indicia and/or stamps, wherein the indicia includes a sticker indicating fragility of the object, wherein the step of comparing includes comparing the shape of the object to the shapes of the objects within the database, wherein the step of comparing includes comparing the colour of the object to the colours of the objects within the database, wherein the step of comparing includes comparing a combination of features of the object to a corresponding combination of features of the objects within the database and wherein the combination of features is selected from shapes, colours, height, depth, width, quantity, weight or a combination thereof;

3-9. (canceled)

10. The process of claim 1, wherein the objects in the database are associated with reference identification information selected from shapes, colours, height, depth, width, quantity, weight or a combination thereof, and with reference packaging and/or shipping information.

11. The process of claim 1, wherein packaging and/or shipping information includes minimum package size, recommended package size, minimum weight bearing package strength, recommended weight bearing package strength, special shipping requirements, fragility, starting location, shipping location, required package shape, alternative package shapes, recommended shipping standards and/or luxury shipping standards.

12. (canceled)

13. The process of claim 1, wherein the ordering of the packaging and/or shipping materials includes ordering from a post office or shipping materials provider to send the materials to the user at the starting location.

14. The process of claim 1, wherein the ordering of the packaging and/or shipping materials includes an initial step of obtaining quotes from suppliers.

15. The process of claim 1, comprising obtaining the optical image from the object using a mobile phone or tablet device and sending the optical image via the mobile phone or tablet device to the database.

16. The process of claim 15, wherein the database is associated with a server and the optical image is sent by the mobile phone or tablet device to the database via the server wherein the mobile phone or tablet device comprises a software application for obtaining the optical image; wherein the mobile phone or tablet device comprises a software application for sending the optical image;

17-18. (canceled)

19. The process of claim 16, wherein the mobile phone or tablet device comprises a software application for ordering or purchasing the packaging and/or shipping materials; wherein the software applications for obtaining the optical image, sending the optical image, and ordering or purchasing the packaging and/or shipping materials, are separate from each other;

20. (canceled)

21. The process of claim 19, wherein the software applications for obtaining the optical image, sending the optical image, and ordering or purchasing the packaging and/or shipping materials, are part of the same overall software application; comprising allowing the user to purchase the packaging and/or shipping materials in an external application with respect to obtaining and sending the optical image;

22. (canceled)

23. The process of claim 1, wherein the database is crowd sourced; wherein the database comprises objects described by the user, which objects will only be accessible by that user for supplying the packaging and/or shipping materials corresponding to those objects; wherein the objects are any physical objects;

24. The process of claim 23, comprising building the crowd sourced database by:
providing a platform for the users to send the optical images of the corresponding objects for packaging and/or shipping identification;
receiving either the optical images of the objects from the users or keywords associated with the object via the search bar from the users;
for each object, either comparing with the optical recognition program the optical image of the object to images of objects within the crowd sourced database of objects or comparing identical such keywords in the search bar with the words used in the description of the objects in the crowd sourced database of objects;
for objects not found in the crowd sourced database:
receiving a description of the object; and
receiving either optical images of the objects from the users or keywords associated with the object via a search bar; and
for each object, either comparing with optical recognition program the optical image of the object to images of objects within the crowd sourced database of objects or compare identical such keywords in the search bar with the words used in the description of the objects in the crowd sourced database of objects, and/or;
ordering packaging and/or shipping materials for the object and/or;
supplying the packaging and/or shipping materials to the corresponding user; and
for objects found in the crowd sourced database:
ordering packaging materials for the identified object, and supplying the packaging and/or shipping materials to the corresponding user; and
supplying the packaging and/or shipping materials to the corresponding user.

25-27. (canceled)

28. A process for building a crowd sourced database of objects for packaging and/or shipping the objects, comprising:
providing a platform for users to send optical images of corresponding objects for packaging and/or shipping identification;
receiving either optical images of the objects from the users or keywords associated with the object, optionally via a search bar
for each object, either comparing with optical recognition program the optical image of the object to images of objects within the crowd sourced database of objects or comparing identical such keywords in the search bar with the words used in the description of the objects in the database of objects;
receiving a description of the object and/or packaging and/or shipping information from at least some of the users regarding the corresponding objects and updating the crowd sourced database therewith;
for objects not found in the crowd sourced database:
receiving packaging and/or shipping information from the corresponding user and updating the crowd sourced database therewith, and
ordering packaging and/or shipping materials for the object; and
supplying the packaging and/or shipping materials to the corresponding user; and
for objects found in the crowd sourced database:
ordering packaging materials for the identified object, and
supplying the packaging and/or shipping materials to the corresponding user.

29. (canceled)

30. System for providing users with packaging and/or shipping materials, comprising:
an image acquisition device operable for obtaining an optical image of an object;
a database comprising packaging and/or shipping information and optical images associated with objects and their description;
a network or communication means between the image acquisition device and the database; and
a processing device programmed to:
compare the optical image of the object to images of objects within the database of objects to identify the object; and/or
compare identical such keywords in a search bar with the words used in the description of the objects in the database of objects; and
ordering the packaging and/or shipping materials for the identified object.

31. A process for providing users with packaging and/or shipping materials comprising:
receiving either an optical image of an object having a starting location and a shipping location or keywords associated with the object via a search bar;
comparing either, with an optical recognition program, the optical image of the object to images of objects within a database of objects to identify the object within a category of objects, or the keywords in the search bar with words used in a description of the object in the database of objects, and wherein the object is within a category of objects; wherein the data comprises optical data; wherein the optical data comprises a digital photograph and/or a bar code and/or a QR code;
wherein the category of objects has a description and/or packaging and/or shipping information associated to the category comprising average packaging and/or shipping information of the objects in the category; and
ordering and/or receiving quotes for the packaging and/or shipping materials for the identified category of objects and, optionally, supplying the packaging and/or shipping materials to the user at the starting location.
transferring data related to an object having a starting location and a shipping location, from a mobile phone or tablet device to a database;
comparing the data of the object to data of objects within the database of objects to identify the object; wherein the data comprises the description of the object including a category of the object and/or more or more associated trademarks of the object.
assigning packaging and/or shipping information to the identified object; and
allowing the user to obtain the packaging and/or shipping materials based on the packaging and/or shipping information for the identified object.

32-36. (canceled)
